(19) United States
(12) Patent Application Publication
(10) Pub. No.: US 2026/0327433 A1
(43) Pub. Date: Oct. 22, 2026

(54) AQUEOUS COATING AGENT

(71) Applicant: Henkel AG & Co. KGaA, Düsseldorf (DE)

(72) Inventors: Chiho Sakoda, Osaka (JP); Yoshio Yoshida, Osaka (JP); Basil Tassigiannakis, Kilsyth Victoria (AU)

(21) Appl. No.: 19/693,724

(22) Filed: Jun. 1, 2026

Related U.S. Application Data
(63) Continuation of application No. PCT/JP2024/043193, filed on Dec. 6, 2024.

(30) Foreign Application Priority Data
Dec. 13, 2023 (JP) 2023-210165

(51) Int. Cl. C09D 5/02; C09D 7/40; C09D 7/65; C09D 109/08; C09D 123/08; C09D 125/14; C09D 133/00; D21H 19/12; D21H 19/20; D21H 27/10

(52) U.S. Cl. CPC C09D 5/024; C09D 7/65; C09D 7/69; C09D 7/70; C09D 109/08; C09D 123/0853; C09D 125/14; C09D 133/00; D21H 19/12; D21H 19/20; D21H 27/10

(57) ABSTRACT

Disclosed is an aqueous coating agent comprising: (A) thermally expandable microcapsule; and (B) a thermoplastic resin, wherein the aqueous coating agent comprises the component (A) in an amount less than 15 parts by mass based on 100 parts by mass of the total of the components (A) and (B).

### TECHNICAL FIELD

The present invention relates to: an aqueous coating agent with which a paper base material is coated; and a paper base material that is coated with the aqueous coating agent. The present invention further relates to a packaging body (for example, a packaging bag, a container, a box, or the like) that is obtained by processing the paper base material.

### BACKGROUND ART

A reduction of plastic products is recommended throughout the world in consideration of environmental problems. Such plastic products are incapable of naturally decomposing, and it is difficult to dispose of the plastic products. Moreover, burning of plastics may result in generation of dioxin and may cause air pollution.

Further, in recent years, possibilities that plastic refuse is discarded in the sea and decomposes into microlevels to form small pieces of debris, fish in the sea eat the debris, and humans eat the fish have been perceived as problems.

Given such a backdrop, the replacement of plastic base materials with paper base materials has been examined in various fields, and particularly in the food field, processing of paper base materials instead of plastic base materials has been attempted to produce packaging bodies (for example, packaging bags for foods, containers such as paper cups, boxes, and the like). In the architecture field, paper base materials have been processed to produce packaging bodies (for example, powder packaging bags for cement and the like, and the like).

Laminated paper has been known to be used as one form of packaging bodies. Commonly, laminated paper is obtained by laminating a polyethylene film or the like on a paper base material. In recent years, recycling of laminated paper has been required due to raising of environmental awareness. However, since the recycling of laminated paper requires a special device, a technique of coating a film with an aqueous resin has been used.

Patent Literature 1 teaches that an aqueous ethylene-based resin dispersion comprising an ethylene-acrylic acid copolymer neutralized with ammonia or an amine and another olefinic thermoplastic resin is useful as a heat sealant for a paper base material or an aluminum foil base material (see [Claims], [0025], [0027], [0028], [0029], [0030], [0035], [0044], and the like).

Patent Literature 1 discloses that an excellent heat-sealing property is offered by applying the aqueous ethylene-based resin dispersion described above to a paper base material or an aluminum foil base material, drying the material, and then heat-sealing the applied portion at 80 or 120 °C (see [0027], [0030], [0035], [0044], and the like).

Patent Literature 2 discloses that an acrylic pressure sensitive adhesive comprising thermally expandable microspheres and a copolymer of butyl acrylate and acrylic acid is produced (see [0039] to [0040]), a paper-made lid attached to a polymer-made tray in which a small amount of water is put is glued (at room temperature) using the pressure sensitive adhesive to produce a food packaging body, the food packaging body is then put and heated at 120 °C for 2 minutes in a microwave oven, whereby the adhesive strength of the adhesive layer is lost to peel the lid (see [Claims], [0003], [0004],] and [0040] to [0041]).

However, it is difficult to heat-seal a packaging body in which a content adheres to a sealing portion when the aqueous dispersion or the pressure sensitive adhesive according to Patent Literatures 1 to 2 is used as a coating agent. In particular, when the content in the packaging body is an article such as a powder that can be easily scattered, such an article may float and adhere to the seal portion of the packaging body, whereby a heat-sealing property may be deteriorated. Accordingly, an aqueous coating agent is required to enable a packaging body to be heat-sealed even in a seal portion to which a content in the packaging body adheres. In addition, Patent Literature 2 discloses the pressure sensitive adhesive, which is incapable of being used as a heat sealant.

### CITATION LIST

### Patent Literature

[PTL 1] JP 2000-7860 A
[PTL 2] JP 2000-302178 A

### SUMMARY OF INVENTION

### Technical Problem

The present invention was accomplished to solve the problems described above. An objective of the present invention is to provide an aqueous coating agent excellent in heat-sealing properties for a paper base material, particularly excellent even in heat-sealing properties for a packaging body comprising a seal portion of a paper base material to which a content (more specifically, a powder) adheres. Moreover, an objective of the present invention is to provide a paper base material coated with the coating agent.

### Solution to Problem

As a result of repeating diligent study, the present inventors found that an aqueous coating agent excellent in heat-sealing properties, particularly excellent even in heat-sealing properties for a packaging body comprising a seal portion of a paper base material to which a content (more specifically, a powder) adheres, is obtained by allowing the aqueous coating agent to comprise a thermoplastic resin and specific microcapsules, and limiting the amount of the blended microcapsules in a specific range, and the present invention was thus accomplished.

In other words, the present specification comprises the following embodiments.
1. An aqueous coating agent comprising: (A) thermally expandable microcapsules; and (B) a thermoplastic resin,
wherein the amount of the component (A) is less than 15 parts by mass based on 100 parts by mass of the total of the components (A) and (B).
2. The aqueous coating agent according to 1, wherein (B) the thermoplastic resin has a glass transition temperature of 40 °C or less.
3. The aqueous coating agent according to 1 or 2, wherein the thermally expandable microcapsules (A) and the thermoplastic resin (B) are dispersed in an aqueous medium.
4. The aqueous coating agent according to any of 1 to 3, wherein the thermally expandable microcapsules (A) comprise an outer shell and a blowing agent which is comprised in the outer shell and vaporizes by heat.
5. The aqueous coating agent according to any of 1 to 4, wherein the thermally expandable microcapsules (A) have an expansion start temperature that is lower than a maximum expansion temperature, have an expansion start temperature of 65 to 200 °C, and have a maximum expansion temperature of 100 to 350 °C.
6. The aqueous coating agent according to any of 1 to 5, wherein the thermoplastic resin (B) comprises at least one constitutional unit selected from a constitutional unit derived from a polymer of (meth)acrylate ester and a constitutional unit derived from a styrene polymer.
7. The aqueous coating agent according to any of 1 to 6, wherein the thermoplastic resin (B) comprises both of a copolymer of methyl methacrylate and 2-ethylhexyl acrylate, and a styrene-butadiene copolymer.
8. A paper base material coated with the aqueous coating agent according to 1 to 7.
9. A packaging body comprising a paper base material according to 8.
10. The packaging body according to 9, wherein the packaging body comprises a powder.

### Advantageous Effects of Invention

An aqueous coating agent of an embodiment of the present invention comprises (A) thermally expandable microcapsules and (B) a thermoplastic resin, wherein the amount of the component (A) is less than 15 parts by mass based on 100 parts by mass of the total of the components (A) and (B). Therefore, in the aqueous coating agent, heat-sealing properties for a paper base material (particularly, heat-sealing properties for a packaging body comprising a seal portion of a paper base material to which a content adheres) are considerably improved.

The low content of the component (A) allows the seal portion of the paper base material of a packaging bag to be coated uniformly with the aqueous coating agent of the present invention, results in improvement in adhesiveness and peel strength, and enables an expansion percentage to be also kept at a certain level.

The aqueous coating agent of the embodiment of the present invention is expanded by heat. Therefore, even if a content (a powder, more specifically, wheat flour, a cement powder, or the like) adheres to a sealing surface, the aqueous coating agent encompasses the content, and adhesiveness with a seal portion is improved.

Even if a content such as a powder adheres to a seal portion of a packaging body, the packaging body is preferably heat-sealed by coating the seal portion with the aqueous coating agent of the embodiment of the present invention.

As described above, the aqueous coating agent of the embodiment of the present invention can be used in various packaging fields (for example, food, architecture, and the like) without limiting the content of a packaging body to a liquid and a powder because a seal portion to which the content of the packaging body adheres can be preferably heat-sealed with the aqueous coating agent.

A paper base material of an embodiment of the present invention is coated with the aqueous coating agent of the embodiment described above and becomes a packaging body excellent in heat-sealing properties even when a content of a food packaging bag, a packaging bag comprising a powder such as cement, or the like may adhere to a seal portion.

### DESCRIPTION OF EMBODIMENTS

An aqueous coating agent (also simply referred to as “coating agent”) of an embodiment of the present invention comprises thermally expandable microcapsules (A) (also referred to as “component (A)” or “microcapsules (A)”) and a thermoplastic resin (B) (also referred to as “component (B)”).

The aqueous coating agent of the embodiment of the present invention comprises the component (A) in an amount less than 15 parts by mass based on 100 parts by mass of the total of the components (A) and (B). The content of the component (A) is less than 15 parts by mass, and therefore, the aqueous coating agent of the embodiment of the present invention is excellent in heat-sealing properties for a paper base material, and can heat-seal a seal portion even if a powder or the like adheres to the seal portion.

In the present invention, the content of the component (A) is more preferably 1 to 13 parts by mass, still more preferably 1 to 10 parts by mass, and most desirably 2 to 9 parts by mass based on 100 parts by mass of the total of components (A) and (B).

The content of the component (A) in the aqueous coating agent of the embodiment of the present invention is 1 to 13 parts by mass, and therefore, the aqueous coating agent enables the heat-sealing properties to be kept at a higher level, and enables a seal portion to which a powder or a liquid substance adheres to be more preferably heat-sealed.

The aqueous coating agent of the embodiment of the present invention refers to a coating agent in which a polymer (for example, the component (B) or the like) can be dispersed and/or dissolved in an aqueous medium, and is preferably an aqueous emulsion (aqueous dispersion) obtained by dispersing a polymer in an aqueous medium. When the aqueous coating agent of the embodiment of the present invention is an aqueous emulsion, the aqueous coating agent can be used even in a field that is severe in a hygiene viewpoint, such as a food field.

Herein, “aqueous medium” refers to common water such as city water, distilled water, or ion-exchanged water, may comprise an organic solvent that is soluble or dispersible in water and has poor reactivity with a raw material such as a monomer of resin related to the present invention, for example, acetone, ethyl acetate, or the like, may further comprise a monomer, oligomer, prepolymer, resin, and/or the like soluble or dispersible in water, and may comprise an emulsifier, polymerizable emulsifier, polymerization reaction initiator, chain extender, various additives, and/or the like commonly used when an aqueous resin or water-soluble resin is produced, as described later.

The constituent features of the aqueous coating agent of the embodiment of the present invention are described below.

### <(A) Thermally Expandable Microcapsule>

Herein, the thermally expandable microcapsule (A) comprises a microcapsule structure comprising an outer shell (shell) and a blowing agent comprised in the outer shell. By heating the blowing agent comprised in the outer shell (shell), the blowing agent is vaporized, the thermoplastic outer shell is expanded, and the thermoplastic microcapsule (A) can be expanded.

The outer shell comprises a thermoplastic resin obtained by polymerizing a polymerizable component (a), and the thermoplastic resin may be the same as or different from a thermoplastic resin (B) described later.

The polymerizable component (a) comprises a polymerizable monomer (a1) as an essential component, and may comprise a crosslinking agent (a2).

The polymerizable monomer (a1) is a monomer having a radical polymerizable carbon-carbon double bond. The monomer is an addition polymerizable monomer. Moreover, the crosslinking agent means a monomer having at least two radical polymerizable carbon-carbon double bonds, and is a component can introduce a crosslinking structure into a thermoplastic resin.

Examples of the polymerizable monomer (a1) comprise:
alkoxypolyoxyalkylene mono(meth)acrylates such as methoxypolyethylene glycol mono(meth)acrylate, methoxypolypropylene glycol mono(meth)acrylate, methoxypolybutylene glycol mono(meth)acrylate, methoxypolyethylene glycol-polypropylene glycol mono(meth)acrylate, methoxypolyethylene glycol-polybutylene glycol mono(meth)acrylate, methoxypolypropylene glycol-polybutylene glycol mono(meth)acrylate, octylpolyethylene glycol mono(meth)acrylate, lauroxypolyethylene glycol mono(meth)acrylate, and stearoxypolyethylene glycol mono(meth)acrylate; phenoxypolyoxyalkylene mono(meth)acrylates such as phenoxypolyethylene glycol mono(meth)acrylate; polyalkylene glycol mono(meth)acrylates such as polyethylene glycol mono(meth)acrylate, polypropylene glycol mono(meth)acrylate, polybutylene glycol mono(meth)acrylate, polyethylene glycol-polypropylene glycol mono(meth)acrylate, polyethylene glycol-polybutylene glycol mono(meth)acrylate, and polypropylene glycol-polybutylene glycol mono(meth)acrylate; mono(2-acryloyloxyethyl) succinate; and polylactone mono(meth)acrylates such as ω-carboxy-polycaprolactone mono(meth)acrylate.

Herein, the term “(meth)acrylate” means an acrylate or a methacrylate. Such polymerizable monomers may be used singly, or in combination of two or more kinds thereof.

The polymerizable monomer (a1) may further comprise a nitrile-based monomer as well as the monomer components described as examples above. When the nitrile-based monomer is comprised, the solvent resistance of the thermally expandable microcapsule can be improved. When the polymerizable component comprises the nitrile-based monomer, the weight proportion of the nitrile-based monomer to the polymerizable component (A) is preferably 5 to 95% by mass, more preferably 10 to 90% by mass, still more preferably 15 to 85% by mass, particularly preferably 20 to 80% by mass, and most preferably 25 to 75% by mass.

The content of the polymerizable monomer (a1) comprised in the polymerizable component (A) is preferably 5 to 100% by mass, still more preferably 10 to 90% by mass, particularly preferably 15 to 80% by mass, and most desirably 20 to 75% by mass.

When the content of the polymerizable monomer (a1) is 5 to 100% by mass, the outer shell of the thermoplastic microcapsule (A) more easily comprises the blowing agent.

Examples of the crosslinking agent (a2) comprise:
aromatic divinyl compounds such as divinylbenzene; and
polyfunctional (meth)acrylate compounds such as allyl methacrylate, triacrylformal, triaryl isocyanate, ethylene glycol di(meth)acrylate, diethylene glycol di(meth)acrylate, triethylene glycol di(meth)acrylate, neopentyl glycol di(meth)acrylate, polytetramethylene glycol diacrylate, 1,4-butanediol di(meth)acrylate, 1,6-hexanediol di(meth)acrylate, 1,9-nonanediol di(meth)acrylate, PEG #200 di(meth)acrylate, PEG #400 di(meth)acrylate, PEG #600 di(meth)acrylate, trimethylolpropane tri(meth)acrylate, pentaerythritol tri(meth)acrylate, pentaerythritol tetraacrylate, dipentaerythritol hexaacrylate, 2-butyl-2-ethyl-1,3-propanediol diacrylate, and tricyclodecane dimethanol di(meth)acrylate. These crosslinking agents may be used singly, or in combination of two or more kinds thereof.

The content of the crosslinking agent (a2) comprised in the polymerizable component (a) is preferably 0 to 5.0 parts by weight, more preferably 0.01 to 3.0 parts by weight, still more preferably 0.02 to 2.0 parts by weight, and particularly preferably 0.05 to 1.5 parts by weight based on 100 parts by mass of the polymerizable component (a).

Since the content of the crosslinking agent (a2) is in the range described above, the thermally expandable microcapsule (A) is superior in expansion performance.

Herein, the blowing agent is a component that is vaporized by heating, and is comprised in the outer shell comprised in the thermally expandable microcapsule (A). The thermally expandable microcapsule (A) comprises the blowing agent, whereby the outer shell (shell) is swollen by heating, and the thermally expandable microcapsule has a thermal expansion property.

Examples of the blowing agent comprise:
straight-chain hydrocarbons such as propane, butane, pentane, hexane, heptane, octane, nonane, decane, dodecane, tridecane, tetradecane, pentadecane, hexadecane, heptadecane, octadecane, and nanodecane;
branched-chain hydrocarbons such as isobutane, isopentane, isohexane, isoheptane, isooctane, isononane, isodecane, isododecane, 3-methylundecane, isotridecane, 4-methyldodecane, isotetradecane, isopentadecane, isohexadecane, 2,2,4,4,6,8,8-heptamethylnonane, isoheptadecane, isooctadecane, isonanodecane, and 2,6,10,14-tetramethylpentadecane;
hydrocarbons having cyclic structure such as cyclododecane, cyclotridecane, hexylcyclohexane, heptylcyclohexane, n-octylcyclohexane, cyclopentadecane, nonylcyclohexane, decylcyclohexane, pentadecylcyclohexane, hexadecylcyclohexane, heptadecylcyclohexane, and octadecylcyclohexane;
petroleum ethers;
halides thereof;
fluorine-containing compounds such as hydrofluoroether;
tetraalkylsilane; and
compounds that are thermally decomposed to generate gas by heating.

The blowing agent may be any of straight-chain, branched-chain, and alicyclic blowing agents, and more preferably an aliphatic blowing agent. Such blowing agents may be used singly, or in combination of two or more kinds thereof.

The average particle diameter of the thermally expandable microcapsules (A) of the present invention is preferably 0.5 to 200 μm, particularly preferably 1 to 150 μm, still more preferably 2 to 75 μm, and most desirably 5 to 50 μm. When the average particle diameter of the thermally expandable microcapsules (A) is 0.5 to 200 μm, the balance of the thermal expansibility and expansion stability of the component (A) is superior.

Herein, the average particle diameter of the thermally expandable microcapsules (A) can be measured according to a method described in [0077] in Examples in JP 2023-35309 A.

The inclusion rate of the blowing agent is defined as a percentage of the weight of the blowing agent comprised in the component (A) to 100 parts by mass of the component (A). The inclusion rate of the blowing agent is preferably 1 to 50% by mass, particularly preferably 2 to 45% by mass, still more preferably 5 to 40% by mass, and most desirably 10 to 35% by mass. The inclusion rate of the blowing agent is calculated by a method described in [0079] to [0080] in Examples in JP 2023-35309 A.

The expansion start temperature (Ts) of the thermally expandable microcapsules (A) is preferably 65 to 200 °C, more preferably 65 to 150 °C, particularly preferably 70 to 150 °C, and most desirably 70 to 100 °C. When the expansion start temperature (Ts) is 65 to 200 °C, the more sufficient heat resistance of the thermally expandable microcapsules (A) is obtained.

The maximum expansion temperature (Tmax) of the thermally expandable microcapsules (A) is not the particularly limited, and is preferably 100 to 350 °C, still more preferably 100 to 190 °C, particularly preferably 110 to 185 °C, and most desirably 110 to 135 °C. When the maximum expansion temperature (Tmax) is 100 to 350 °C, the thermally expandable microcapsules (A) are superior in the balance of heat resistance and an expansion percentage.

Moreover, the expansion start temperature (Ts) and maximum expansion temperature (Tmax) of the thermally expandable microcapsules are calculated by a method described in [0078] in Examples in JP 2023-35309 A.

In the present invention, the volume maximum expansion magnification of the thermally expandable microcapsules (A) is preferably 3 to 50 times, still more preferably 5 to 20 times, particularly preferably 5 to 15 times, and most desirably 5 to 10 times. When the volume maximum expansion magnification of the component (A) is 3 to 50 times, the aqueous coating agent of the embodiment of the present invention causes a larger amount of a powder adhering to a seal portion to be taken in the interior of the coating agent and also enables adhesiveness with the seal portion to be more maintained.

In the present invention, the thermally expandable microcapsules (A) are different from so-called hollow particles. Such hollow particles do not comprise a blowing agent, or a blowing agent has already been vaporized from such hollow particles. Therefore, such hollow particles are not thermally expanded.

A commercially available product can be used as the thermally expandable microcapsules (A). Examples of the commercially available product comprise Microsphere F36D, F35D, F48D, F65D, FN100S, F100M, FN100M, FN180, F190D, F230D, F260D, F2800D, F2830D, F2860D, or the like, manufactured by Matsumoto Yushi-Seiyaku Co., Ltd.

Examples of the commercially available products of the hollow particles comprise Microsphere F30E, F50E, F65E, F65DE, F80DE, or the like, manufactured by Matsumoto Yushi-Seiyaku Co., Ltd.

### <(B) Thermoplastic Resin>

Herein, the thermoplastic resin (B) refers to a resin that has characteristics of being softened and capable of being molded by heating, and being solidified by cooling, and is obtained by polymerizing a polymerizable unsaturated monomer (b).

In the present embodiment, “polymerizable unsaturated monomer” refers to a radical polymerizable monomer having an ethylenic double bond. “Ethylenic double bond” refers to a double bond between carbon atoms, of which polymerization reaction (radical polymerization) can occur. Examples of functional groups having such ethylenic double bonds may comprise a vinyl group (CH2=CH—), (meth)allyl groups (CH2=CH—CH2- and CH2=C(CH3)-CH2-), (meth)acryloyloxy groups (CH2=CH—COO— and CH2=C(CH3)-COO—), (meth)acryloyloxyalkyl groups (CH2=CH—COO—R— and CH2=C(CH3)-COO—R—), and —COO—CH═CH—COO—. The polymerizable unsaturated monomer (b) may be one kind of a monomer, or in combination of two or more kinds of monomers.

In one embodiment of the present invention, the polymerizable unsaturated monomer (b) comprised in the thermoplastic resin (B) preferably has a chemical structure derived from a carboxylate ester polymer.

“Chemical structure derived from carboxylate ester polymer” means a chemical structure comprising a polymer (regardless of homopolymer or copolymer) of a carboxylate ester having an ethylenic double bond and any modified product of the polymer. “Carboxylate ester polymer” is obtained by polymerizing the polymerizable unsaturated monomer (b) comprising a carboxylate ester (b1) having an ethylenic double bond.

Herein, examples of “carboxylate ester (b1) having ethylenic double bond” (also simply referred to as “carboxylate ester (b1)”) may comprise:
(meth)acrylate esters such as methyl (meth)acrylate, ethyl (meth)acrylate, butyl (meth)acrylate, and 2-ethylhexyl (meth)acrylate;
vinyl carboxylates such as vinyl acetate; and
allyl carboxylates such as allyl acetate.

Herein, (meth)acrylate esters represent both acrylate esters and methacrylate esters.

In the present invention, “carboxylate ester (b1) having ethylenic double bond” is preferably methyl methacrylate, butyl acrylate, or vinyl acetate, and particularly desirably vinyl acetate.

In the present embodiment, the carboxylate ester polymer may be a copolymer of the carboxylate ester (b1) having an ethylenic double bond and a polymerizable unsaturated monomer (b2) (also referred to as “other monomer (b2)”) other than carboxylate esters having ethylenic double bonds.

The other monomer (b2) is not particularly limited, and examples thereof comprise: olefins such as ethylene and propylene; diolefins such as butadiene and isoprene; vinyl aromatic compounds such as styrene and α-methylstyrene; vinyl alcohols; and acrylonitrile.

In the present invention, (b1) preferably comprises a (meth)acrylate ester, and particularly preferably comprises methyl methacrylate, methyl acrylate, or 2-ethylhexyl acrylate, and (b2) preferably includes styrene.

In the present invention, the component (B) preferably comprises at least one constitutional unit selected from constitutional units derived from polymers of (meth)acrylate esters and constitutional units derived from styrene polymers, particularly preferably comprises both a constitutional unit derived from a polymer of a (meth)acrylate ester and a constitutional unit derived from a styrene polymer, and still more desirably comprises both of a copolymer of methyl methacrylate and 2-ethylhexyl acrylate, and a styrene-butadiene copolymer.

When the component (B) has the composition described above, the excellent peel strength of the aqueous coating agent of the present invention is maintained, and the aqueous coating agent is also excellent in adhesiveness.

Herein, “constitutional unit derived from polymer of (meth)acrylate ester” has a chemical structure comprising a homopolymer or copolymer of a (meth)acrylate ester. “Constitutional unit derived from styrene polymer” has a chemical structure derived from a homopolymer or copolymer of styrene.

In the present invention, the glass transition temperature of the thermoplastic resin (B) is preferably 40 °C or less, particularly preferably −50 °C to 35 °C, still more preferably −40 °C to 35 °C, and most desirably −0 °C to 35 °C. When the glass transition temperature of the component (B) is in the range described above, the aqueous coating agent of the present invention is superior in heat-sealing properties.

Herein, the glass transition temperature of the thermoplastic resin (B) is calculated based on a glass transition temperature (hereinafter also referred to as “homopolymer Tg”) of a homopolymer obtained by homopolymerizing the polymerizable unsaturated monomer (b) which is a raw material of the thermoplastic resin (B).

The glass transition temperature of the thermoplastic resin (B) is determined in consideration of the homopolymer Tg and the mixing ratio (part(s) by mass) of each polymerizable unsaturated monomer (b) (monomer). Specifically, Tg of a copolymer can be determined by calculation using the following equation.

1/Tg=C1/Tg1+C2/Tg2+ . . . +Cn/Tgn

[In the calculation equation, Tg represents theoretical Tg of a copolymer, Cn represents part(s) by mass ratio of an n-th monomer n comprised in the mixture of monomers, Tgn represents homopolymer Tg of the n-th monomer n, and n is the number of monomers comprised in the copolymer, and is a positive integer.]

Values described in the literature can be used as homopolymer Tg. Such literature is, for example, “POLYMER HANDBOOK” (fourth edition, published by John Wiley & Sons, Inc.). As examples, values of homopolymer Tg of monomers, described in POLYMER HANDBOOK, are described below.
Methyl methacrylate (“MMA”, Tg=105 °C)
n-Butyl acrylate (“n-BA”, Tg=−54 °C)
2-Ethylhexyl acrylate (“2EHA”, Tg=−70 °C)
Styrene (“St”, Tg=100 °C)
Acrylic acid (“AA”, Tg=106 °C)
Methacrylic acid (“MAA”, Tg=130 °C)
n-Butyl methacrylate (“BMA”, Tg=20 °C)

The aqueous coating agent concerning the embodiment of the present invention may comprise a viscosity adjuster, a plasticizer, an antifoaming agent, an antiseptic agent, a coloring agent, or the like as an additive, as well as the component (A) and the component (B). These additives may be blended after synthesis of the thermoplastic resin (B), may be blended into a monomer which is a raw material of the thermoplastic resin (B), or may be added to the aqueous coating agent after mixing the component (A) and the component (B).

Examples of the viscosity adjuster may comprise nitrogen-containing substances such as urea, urea compounds, and dicyandiamide, calcium hydroxide, calcium oxide, sodium carbonate, trisodium phosphate, diammonium hydrogen phosphate, borax, sodium fluoride, water glass, and aqueous ammonia.

Examples of the plasticizer may comprise: glycerin; polyhydric alcohols such as ethylene glycol and propylene glycol; sugars such as sucrose and sorbitol; and organic solvents such as cellosolve.

Examples of the antifoaming agent may include:
silicone-based antifoaming agents such as dimethylpolysiloxane, polyoxyalkylene-modified silicone, organic modified polysiloxane, and fluorine silicone;
antifoaming agents based on oils and fats such as castor oil, sesame oil, linseed oil, and animal and vegetable oils;
antifoaming agents based on fatty acids such as stearic acid, oleic acid, and palmitic acid;
antifoaming agents based on fatty acid esters such as Isoamylstearic acid, diglycollauric acid, distearylsuccinic acid, distearic acid, sorbitanmonolauric acid, glycerin fatty acid ester, polyoxyethylene sorbitan, butyl monolaurate stearate, sucrose fatty acid ester, ethylacetic acid alkyl ester of sulfonated ricinate, and natural wax;
alcohol-based antifoaming agent such as polyoxyalkylene glycol and derivatives thereof, polyoxyalkylene alcohol hydrate, diamylphenoxyethanol, 3-heptanol, and 2-ethylhexanol;
ether-based antifoaming agents such as 3-heptylcellosolve and nonylcellosolve-3-heptylcarbitol;
antifoaming agents such as phosphate esters such as tributylphosphate, sodium octyl phosphate, and tris(butoxyethyl)phosphate;
amine-based antifoaming agents such as diamylamine;
amide-based antifoaming agents such as polyalkylene amide, acylate polyamine, and dioctadecanoyl piperidine;
antifoaming agents based on metal soaps such as aluminum stearate, calcium stearate, potassium oleate, and calcium salts of wool olein; and
antifoaming agents based on sulfonic acid esters such as sodium lauryl sulfonate and sodium dodecyl sulfonate.

A surface of a paper base material can be coated with the aqueous coating agent of the present invention. A usual coating method may be used as a method of coating a paper base material with the aqueous coating agent of the present invention. For example, a paper base material is coated with the coating agent of the present invention by using a known coater such as a table coater, a bar coater, a two-roll size press coater, a gate roll coater, a blade metaling coater, a rod metaling coater, a blade coater, an air knife coater, a roll coater, a brush coater, a kiss coater, a squeeze coater, a curtain coater, a die coater, a gravure coater, or a dip coater.

The amount of the aqueous coating agent with which a paper base material is coated is not particularly limited, but is, for example, preferably 5 to 100 g/m2, more preferably 5 to 50 g/m2, and particularly preferably 10 to 20 g/m2 as a solid content (dry mass). Here, the solid content of the coating agent refers to a solid content obtained by drying the coating agent at 105 °C for 3 hours

In another embodiment, the present invention relates to a paper base material of which a surface is coated with the aqueous coating agent described above. The paper base material of the embodiment of the present invention has considerably excellent heat-sealing properties, and can be utilized in a packaging body comprising powder of a food (retort), a construction material, or the like (for example, a food powder such as tea powder, wheat flour, or rice flour, the powder of a construction material such as cement, or the like).

Herein, “powder” is regarded as an aggregate of solid particles (minute solids). The powder comprising solid particles having a particle diameter of 5 mm or less is preferred.

When the powder comprises solid particles having a particle diameter of 5 mm or less, the aqueous coating agent of the embodiment of the present invention enables a seal portion, to which a powder adheres, to be more preferably heat-sealed.

Since the heat-sealing properties of the aqueous coating agent of the embodiment of the present invention are considerably excellent, the seal portion of a packaging body is insusceptible to the influence of adhesion of the content of the packaging body. In particular, a seal portion of a packaging body comprising an article that is easily scattered, such as a powder, may be stained with the article in heat sealing, and may be deteriorated in seal properties. However, the heat-sealing properties of the packaging bag can be maintained by coating the seal portion with the aqueous coating agent of the embodiment of the present invention.

The paper base material is not particularly limited, and known paper or synthetic paper obtained by making from a chemical pulp such as broadleaf tree kraft pulp or coniferous tree kraft pulp, a mechanical pulp such as GP (ground-wood pulp), RGP (refiner ground pulp), or TMP (thermomechanical pulp), or the like can be used as the paper base material. Moreover, premium grade paper, medium grade paper, alkaline paper, glassine paper, semi-glassine paper, or paperboard or white paperboard for use in corrugated fiberboard, a building material, white lined chipboard, chipboard, or the like can be used as the paper base material described above. An organic or inorganic pigment, or a paper-making auxiliary agent such as a paper strong agent, a sizing agent, or a yield improver may be comprised in the paper base material.

In still another embodiment, the present invention relates to a paper product having a paper base material of which a surface is coated with the aqueous coating agent described above. The paper product of the embodiment of the present invention can also be utilized in a paper-made straw, toilet paper, a paper cup, a food packaging bag, a cement bag, or the like.

### EXAMPLES

The present invention is specifically described below in detail with reference to Examples and Comparative Examples. Each of these examples is merely one embodiment of the present invention, and the present invention is not limited at all to these examples. Unless otherwise noted, a portion in which a solvent is not taken into consideration is based on part(s) by mass or % by mass in the description of Examples.

A numerical value related to the amount of each of blended components (A) to (B) set forth in Table 1 represents the part(s) of “solid content excluding solvent (material excluding water)”, and the unit thereof is part(s) by mass. The total amount of the components (A) to (B) is converted into 100 parts by mass, and the part(s) by mass of each component are set forth in Table 1. The details of the components (A) to (B) used in Examples and Comparative Examples are described below.

### (A) Thermoplastic Microcapsule

(A1) Thermally expandable microcapsules (Matsumoto Microsphere F48D, manufactured by Matsumoto Yushi-Seiyaku Co., Ltd., expansion start temperature of 90 to 100 °C, maximum expansion temperature of 125 to 135 °C, average particle diameter of 12 to 19 μm)
(A2) Thermally expandable microcapsules (Matsumoto Microsphere F36D, manufactured by Matsumoto Yushi-Seiyaku Co., Ltd., thermal expansion start temperature of 70 to 85 °C, maximum expansion temperature of 120 to 130 °C, average particle diameter of 12 to 19 μm)
(A′3) Hollow particles (Matsumoto Microsphere F50E, manufactured by Matsumoto Yushi-Seiyaku Co., Ltd., average particle diameter of 40 to 60 μm) (B) Thermoplastic Resin
(B1) Acrylic emulsion (AQUENCE EPIX BC9210, manufactured by Henkel Japan Ltd., glass transition temperature (Tg) of 34 °C)
(B2) Styrene acrylic emulsion (AQUENCE EPIX BC900F, manufactured by Henkel Japan Ltd., glass transition temperature (Tg) of −28 °C)
(B3) Styrene butadiene emulsion (SB Latex A7301, manufactured by Asahi-Kasei Chemicals Corporation, glass transition temperature (Tg) of −8 °C)
(B4) Olefin dispersion (AQUECNE EPIX BC9220HS, manufactured by Henkel Japan Ltd., glass transition temperature (Tg) of −37 °C)
(B5) Ethylene-vinyl acetate emulsion (SUMIKAFLEX S400HQ, manufactured by Sumika Chemtex Company, Limited, glass transition temperature (Tg) of 0 °C)

### Preparation of Aqueous Coating Agent and Production of Paper Base Material

### Example 1

### <Preparation of Aqueous Coating Agent>

1000 g of (B1) acrylic emulsion (trade name: AQUECNE EPIX BC9210, manufactured by Henkel Japan Ltd., solid content of 50% by mass) as a thermoplastic resin (B) was put into a separable flask of 2000 mL in capacity equipped with an agitating blade having a diameter of 150 mm, and 50 g of (A1) thermally expandable microcapsules (trade name: Matsumoto Microsphere F48D, manufactured by Matsumoto Yushi-Seiyaku Co., Ltd.) was added under agitation. The contents in the flask were agitated for 30 minutes to obtain an aqueous coating agent of Example 1.

### <Production of Paper Base Material>

White premium grade paper having a basis weight of 104.7 g/m2, a thickness of 126 μm, and an opacity of 94% (trade name: Premium Grade (manufactured by Chuetsu Pulp & Paper Co., Ltd.)) was coated with the aqueous coating agent of Example 1 by a bar coater so that the amount of coating after drying of the aqueous coating agent was 20 g/m2.

A paper base material coated with the coating agent was put in a drying machine, and dried at 75 to 90 °C to obtain a paper base material of Example 1.

### Example 2

An aqueous coating agent and a paper base material of Example 2 were obtained using conditions similar to those in Example 1, except that (B2) (trade name: AQUECNE EPIX BC900F, manufactured by Henkel Japan Ltd., solid content of 46% by mass) was used as a thermoplastic resin (B).

### Examples 3 to 10 and Comparative Examples 1 to 6

As the components (A) and (B) used in Example 1, components and the proportions thereof, set forth in Tables 1 and 2, were added in a separable flask, and aqueous coating agents and paper base materials were obtained, respectively, under conditions similar to those in Example 1.

The heat-sealing properties (adhesiveness, peel strength, and expansibility) of the aqueous coating agents were evaluated on the aqueous coating papers of these Examples and Comparative Examples, as set forth in Tables 1 and 2.

The details of the evaluation tests for the heat-sealing properties are as follows.

<Adhesiveness of Seal Portion to which Powder Adhered>

The paper base materials obtained in Examples 1 to 10 and Comparative Examples 1 to 6 were cut into a size of 25 mm×100 mm to produce test bodies A and B for an adhesion test. A cement powder was sprinkled on the coating agent coating surface of the test body A. The amount of the cement powder sprinkled on per square meter of the coating surface of the test body A was 15 to 20 g.

The coating surface (to which the cement powder adhered) of the test body A and the coating agent coating surface (to which the cement powder did not adhere) of the test body B were stacked and set in a pressing machine. Press conditions were a temperature of 130 °C, a pressure of 0.6 MPa, and a time of 0.6 seconds.

The pressed test body was cured at room temperature (23 °C) for 2 hours, the coating surface was then peeled at a speed of 300 mm/min by a T-type peeling test machine (TENSILON), and a peeled portion was visually observed, and evaluated. The criteria of the evaluation are as follows.

Herein, material failure refers to failure of a paper base material after peeling.
Excellent: Material failure of 90% or more of heat seal portion
Good: Material failure of 50% or more and less than 90% of heat seal portion
Fair: Material failure of 30% or more and less than 50% of heat seal portion
Poor: Material failure of less than 30% of heat seal portion, or no adhesion
   <Peel Strength of Seal Portion to which Powder Adhered>

The paper base materials obtained in each of Examples and Comparative Examples were cut into a size of 25 mm×100 mm to produce test bodies A and B for a peel strength test. A cement powder was sprinkled on the coating agent coating surface of the test body A. The amount of the cement powder sprinkled on per square meter of the coating surface of the test body A was 15 to 20 g.

The coating surface (to which the cement powder adhered) of the test body A and the coating agent coating surface (to which the cement powder did not adhere) of the test body B were stacked and set in a pressing machine. Press conditions were a temperature of 130 °C, a pressure of 0.6 MPa, and a time of 0.6 seconds.

The pressed test body was cured at room temperature (23 °C) for 2 hours, the coating surface was then peeled at a speed of 300 mm/min by a T-type peeling test machine (TENSILON), and a peeled portion was visually observed, and evaluated.

The criteria of the evaluation are as follows.
Excellent: Peel strength of heat seal portion of 2 N/25 mm or more
Good: Peel strength of heat seal portion of 1 N/25 mm or more and less than 2 N/25 mm
Fair: Peel strength of heat seal portion of 0.5 N/25 mm or more and less than 1 N/25 mm
Poor: Peel strength of heat seal portion of less than 0.5 N/25 mm, or no adhesion
   <Adhesiveness of Seal Portion to which Powder Did not Adhere>

The paper base materials obtained in Examples 1 to 10 and Comparative Examples 1 to 6 were cut into a size of 25 mm×100 mm to produce test bodies A and B for an adhesion test.

The coating surface of the test body A and the coating surface of the test body B were stacked and set in a pressing machine. Press conditions were a temperature of 130 °C, a pressure of 0.6 MPa, and a time of 0.6 seconds.

The pressed test body was cured at room temperature (23 °C) for 2 hours, the coating surface was then peeled at a speed of 300 mm/min by a T-type peeling test machine (TENSILON), and a peeled portion was visually observed, and evaluated.

The criteria of the evaluation are as follows.
Excellent: Material failure of 90% or more of heat seal portion
Good: Material failure of 50% or more and less than 90% of heat seal portion
Fair: Material failure of 30% or more and less than 50% of heat seal portion
Poor: Material failure of less than 30% of heat seal portion, or no sealed
   <Expansion Percentage of Seal Portion to which Powder Did not Adhere>

Heat seal paper obtained in each of Examples and Comparative Examples was cut into a size of 25 mm×100 mm to produce test bodies A and B for an adhesion test.

The coating surface of the test body A and the coating surface of the test body B were stacked and set in a pressing machine. Press conditions were a temperature of 130 °C, a pressure of 0.6 MPa, and a time of 0.6 seconds.

The thicknesses of the base materials of the test bodies A and B before pressing had been measured in advance, the thicknesses of the base materials of the test bodies A and B were measured after the pressing, and an expansion percentage after heat sealing was calculated.

The criteria of the evaluation are as follows.
Excellent: Expansion percentage of heat seal portion of 200% or more
Good: Expansion percentage of heat seal portion of 150% or more and less than 200%
Fair: Expansion percentage of heat seal portion of 110% or more and less than 150%
Poor: Expansion percentage of heat seal portion of less than 110%

TABLE 1

| | | Example | | | | | | | |
|---|---|---|---|---|---|---|---|---|---|
| | | 1 | 2 | 3 | 4 | 5 | 6 | 7 | 8 |
| (A) | A1 | 9.0 | 9.0 | 3.8 | 2.0 | 9.0 | | 9.0 | 9.0 |
| (A′) | A2 | | | | | | 9.0 | | |
| | A′3 | | | | | | | | |
| (B) | B1 | 91.0 | | 96.2 | 98.0 | 45.5 | 45.5 | | |
| | B2 | | 91.0 | | | | | | |
| | B3 | | | | | 45.5 | 45.5 | | |
| | B4 | | | | | | | 91.0 | |
| | B5 | | | | | | | | 91.0 |
| Total | | 100 | 100 | 100 | 100 | 100 | 100 | 100 | 100 |
| Evalu- | Adhesiveness of seal | Good | Good | Good | Fair | Excellent | Excellent | Good | Good |
| ation | portion to which | | | | | | | | |
| | powder adhered | | | | | | | | |
| | Peel strength of seal | Excellent | Excellent | Good | Good | Excellent | Excellent | Good | Good |
| | portion to which | | | | | | | | |
| | powder adhered | | | | | | | | |
| | Adhesiveness of seal | Good | Good | Excellent | Excellent | Excellent | Excellent | Good | Good |
| | portion to which | | | | | | | | |
| | powder did not | | | | | | | | |
| | adhere | | | | | | | | |
| | Expansion | Excellent | Excellent | Good | Fair | Excellent | Excellent | Good | Good |
| | percentage of seal | | | | | | | | |
| | portion to which | | | | | | | | |
| | powder did not | | | | | | | | |
| | adhere | | | | | | | | |

TABLE 2

| | | Example | | Comparative Example | | | | | |
|---|---|---|---|---|---|---|---|---|---|
| | | 9 | 10 | 1 | 2 | 3 | 4 | 5 | 6 |
| (A) | A1 | 13.0 | 1.0 | | 16.7 | 28.6 | 44.4 | | |
| (A′) | A2 | | | | | | | | |
| | A′3 | | | 9 | | | | | |
| (B) | B1 | 43.5 | 49.5 | 91 | 83.3 | 71.4 | 55.6 | | |
| | B2 | | | | | | | | |
| | B3 | 43.5 | 49.5 | | | | | | |
| | B4 | | | | | | | 100 | |
| | B5 | | | | | | | | 100 |
| Total | | 100 | 100 | 100 | 100 | 100 | 100 | 100 | 100 |
| Evalu- | Adhesiveness of seal | Excellent | Fair | Poor | Fair | Fair | Poor | Poor | Poor |
| ation | portion to which | | | | | | | | |
| | powder adhered | | | | | | | | |
| | Peel strength of seal | Good | Good | Poor | Poor | Poor | Poor | Poor | Poor |
| | portion to which | | | | | | | | |
| | powder adhered | | | | | | | | |
| | Adhesiveness of seal | Excellent | Excellent | Fair | Good | Good | Poor | Excellent | Excellent |
| | portion to which | | | | | | | | |
| | powder did not | | | | | | | | |
| | adhere | | | | | | | | |
| | Expansion percentage | Excellent | Fair | Poor | Excellent | Excellent | Excellent | Poor | Poor |
| | of seal portion to | | | | | | | | |
| | which powder did not | | | | | | | | |
| | adhere | | | | | | | | |

As set forth in Tables 1 and 2, each of the aqueous coating agents of Examples is considerably excellent in heat-sealing properties because the content of the component (A) in each of the aqueous coating agents of Examples is less than 15 parts by mass based on 100 parts by mass of the total of the components (A) and the (B). It was demonstrated that the aqueous coating agents of Examples enable adhesiveness and peel strength to be maintained at high levels even if a cement powder adheres to a seal portion.

In contrast to the aqueous coating agents of Examples, the aqueous coating agents of Comparative Examples are inferior in heat-sealing properties because each of the aqueous coating agents of Comparative Examples does not include the component (A) or the content of the component (A) in each of the aqueous coating agents of Comparative Examples is excessively high. In particular, all the peel strengths of the seal portions to which the cement powders adhered in Comparative Examples 1 to 6 are poor.

### INDUSTRIAL APPLICABILITY

The present invention can provide an aqueous coating agent. A paper base material is coated with the aqueous coating agent of an embodiment of the present invention to produce a packaging body. Examples of the packaging body comprise food packaging bags, paper cups, and powder packaging bags for cement and the like.

### CROSS-REFERENCE TO RELATED APPLICATION

This application claims priority under Article 4 of the Paris Convention based on Japanese Patent Application No. 2023-210165 filed on Dec. 13, 2023 in Japan. This priority patent application is incorporated herein by reference in its entirety.

1. An aqueous coating agent comprising:
(A) thermally expandable microcapsules having an onset expansion temperature of 65 to 200 °C and maximum expansion temperature of 100 to 350 °C; and
(B) a thermoplastic resin having a glass transition temperature of 40 °C or less,
wherein the amount of the component (A) is less than 15 parts by mass based on 100 parts by mass of the total of the components (A) and (B).

2. The aqueous coating agent according to claim 1, wherein the thermoplastic resin (B) comprises at least one constitutional unit selected from a constitutional unit derived from a polymer of (meth)acrylate ester and a constitutional unit derived from a styrene polymer.

3. The aqueous coating agent according to claim 1, wherein the thermoplastic resin (B) comprises both of a copolymer of methyl methacrylate and 2-ethylhexyl acrylate, and a styrene-butadiene copolymer.

4. The aqueous coating agent according to claim 1, wherein the thermoplastic resin (B) has a glass transition temperature of 0 to 35 °C.

5. The aqueous coating agent according to claim 1, further comprising a viscosity adjuster, a plasticizer, an antifoaming agent, an antiseptic agent, a coloring agent and/or an additive.

6. The aqueous coating agent according to claim 5, wherein the viscosity adjuster is selected from the group consisting of urea, urea compounds, and dicyandiamide, calcium hydroxide, calcium oxide, sodium carbonate, trisodium phosphate, diammonium hydrogen phosphate, borax, sodium fluoride, water glass, aqueous ammonia, and mixtures thereof.

7. The aqueous coating agent according to claim 5, wherein the plasticizer is selected from the group consisting of glycerin polyhydric alcohols sugars, organic solvents, and mixtures thereof.

8. The aqueous coating agent according to claim 5, wherein the antifoaming agent is selected from the group consisting of silicone-based antifoaming agents, oils and fats-based antifoaming agent, fatty acid-based antifoaming agents, ether-based antifoaming agents phosphate ester-based antifoaming agents, amine-based antifoaming agents, amide-based antifoaming agents, metal soap-based antifoaming agents, sulfonic acid ester-based antifoaming agents, and mixtures thereof.

9. A paper base material coated with the aqueous coating agent according to claim 1.

10. A package comprising the paper based material of claim 9.

11. The package body according to claim 10, wherein the packaging body comprises a powder.

12. The package body according to claim 10, wherein the packaging body has a peel strength of 2 N/25 mm or greater measured by:
a. preparing a paper (A) having a size of 25 mm×100 mm;
b. preparing a paper (B) having a size of 25 mm×100 mm;
c. applying the aqueous coating agent on paper (A);
d. sprinkling 15 to 20 g of cement power on top of the coating agent on paper (A);
e. applying paper (B) on top of the cement power, thereby sandwiching the cement power and coating agent between paper (A) and paper (B) and forming the package body;
f. pressing the package body with a pressure of 0.6 MPa for 0.6 seconds;
g. curing the package body at 23 °C for 2 hours; and
h. peeling at a speed 300 mm/min by a T-type peeling test.
